(19) United States
(12) Patent Application Publication
(10) Pub. No.: US 2007/0153758 A1
(43) Pub. Date: Jul. 5, 2007

(54) Apparatus and method for selecting relay station using relay station preamble signal in a multi-hop relay broadband wireless access communication system

(75) Inventors: Hyun-Jeong Kang, Seoul (KR); Jae-Weon Cho, Suwon-si (KR); Sung-Jin Lee, Seoul (KR); Mi-Hyun Lee, Seoul (KR); Song-Nam Hong, Seoul (KR); Pan-Yuh Joo, Seoul (KR); Jun-Young Jung, Yongin-si (KR)

Correspondence Address: THE FARRELL LAW FIRM, P.C., 333 EARLE OVINGTON BOULEVARD, SUITE 701, UNIONDALE, NY, 11553, US

(73) Assignee: Samsung Electronics Co., Ltd., Suwon-si (KR)

(21) Appl. No.: 11/649,171

(22) Filed: Jan. 3, 2007

(30) Foreign Application Priority Data
Jan. 3, 2006 (KR) 2006-0000600

(51) Int. Cl. H04Q 7/24

(52) U.S. Cl. 370/338; 455/67.11

(57) ABSTRACT

An apparatus and method for selecting an RS using an RS preamble signal in a multi-hop relay BWA communication system are provided, in which a BS sends preamble channel allocation information to at least one RS, the at least one RS sends a preamble to an MS according to the preamble channel allocation information, the MS measures the signal strength level of the preamble received from the at least one RS and reports the signal strength level to the BS, and the BS selects an RS for providing a relay service to the MS according to the signal strength level.

### PRIORITY

This application claims priority under 35 U.S.C. § 119 to an application filed in the Korean Intellectual Property Office on Jan. 3, 2006 and assigned Serial No. 2006-600, the contents of which are incorporated herein by reference.

### BACKGROUND OF THE INVENTION

1. Field of the Invention

The present invention relates generally to a multi-hop relay Broadband Wireless Access (BWA) communication system, and in particular, to an apparatus and method for selecting a Relay Station (RS) using an RS preamble signal.

2. Description of the Related Art

Provisioning of services with diverse Quality of Service (QoS) levels at about 100 Mbps to users is an active study area for a future-generation communication system called a 4ₜₕ Generation (4G) communication system. Particularly, active research on provisioning of high-speed service by ensuring mobility and QoS in a BWA communication system such as Wireless Local Area Network (WLAN) and Wireless Metropolitan Area Network (WMAN) is ongoing. Typical examples of the above system are identified in the Institute of Electrical and Electronics Engineers (IEEE) 802.16a system and IEEE 802.16e system standards.

The IEEE 802.16a and IEEE 802.16e communication systems adopt Orthogonal Frequency Division Multiplexing/Orthogonal Frequency Division Multiple Access (OFDM/OFDMA) to the physical channels of WMAN to support a broadband transmission network. IEEE 802.16a considers only a single-cell structure with no regard to mobility of Subscriber Stations (SSs). In contrast, IEEE 802.16e supports the SS's mobility to the IEEE 802.16a communication system. When the mobility of an SS is considered the mobile SS is called an MS.

FIG. 1 illustrates the configuration of a typical IEEE 802.16e communication system.

Referring to FIG. 1, the IEEE 802.16e communication system is configured in a multi-cell structure. Specifically, it is comprised of cells 100 and 150, BSs 110 and 140 for managing cells 100 and 150, respectively, and a plurality of MSs 111, 113, 130, 151 and 153. Signaling is carried out in OFDM/OFDMA between BSs 110 and 140 and MSs 111, 113, 130, 151 and 153. Among MSs 111, 113, 130, 151 and 153, MS 130 is located in a cell boundary area between cells 100 and 150, i.e. in a handover area. When MS 130 moves to cell 150 managed by BS 140 during signal transmission/reception to/from BS 110, the serving BS of MS 130 changes from BS 110 to BS 140.

Because signaling communication between a stationary BS and an MS is performed through a direct link, the IEEE 802.16e system can easily provide a highly reliable wireless link between the BS and the MS. However, because the BS is stationary, the IEEE 802.16e system has a low flexibility in constructing a wireless network. Accordingly, the use of the IEEE 802.16e system makes it difficult to provide an efficient communication service in a radio environment where traffic distribution or call requirements change frequently.

To avert the problem, a multi-hop relay data transmission scheme using fixed RSs, mobile RSs, or general MSs is used in general cellular wireless communication systems such as IEEE 802.16e. The use of the multi-hop relay wireless communication system makes it possible to reconfigure a network in rapid response to a change in the communication environment and to operate the entire wireless network more efficiently. It can expand cell coverage and increase system capacity. When the channel status between a BS and an MS is bad, an RS is installed between them so that the resulting establishment of a multi-hop relay through the RS renders the available radio channel to the MS better. With the use of the multi-hop relay scheme at a cell boundary where the channel status is poor, high-speed data channels become available and cell coverage is expanded.

FIG. 2 illustrates the configuration of a multi-hop relay BWA communication system configured to expand the service coverage of a BS.

Referring to FIG. 2, the multi-hop relay BWA communication system, which is configured in a multi-cell structure, includes cells 200 and 240 BSs 210 and 250 for managing cells 200 and 240, respectively, a plurality of MSs 211 and 213 within the coverage area of cell 200, a plurality of MSs 221 and 223 managed by BS 210 but located in an area 230 outside cell 200, an RS 220 for providing a multi-hop relay path between BS 210 and MSs 221 and 223 within the area 230, a plurality of MSs 251, 253 and 255 within the coverage area of cell 240, a plurality of MSs 261 and 263 managed by BS 250 but in an area 270 outside cell 240, and an RS 260 for providing a multi-hop relay path between BS 250 and MSs 261 and 263 within area 270.

Although MSs 211 and 213 within the coverage area of cell 200 and RS 220 can communicate directly with BS 210, MSs 221 and 223 within area 230 cannot communicate with BS 210, directly. Therefore, RS 220 covering area 230 relays signals between BS 210 and MSs 211 and 223. That is, MSs 221 and 223 exchange signals with BS 210 through RS 220. Meanwhile, although MSs 251, 253 and 255 within the coverage area of cell 240 and RS 260 can communicate directly with BS 250, MSs 261 and 263 within the area 270 cannot communicate directly with BS 250. Therefore, RS 260 covering area 270 relays signals between BS 250 and MSs 261 and 263. That is, MSs 261 and 263 exchange signals with BS 250 through RS 260.

FIG. 3 illustrates the configuration of a multi-hop relay BWA communication system configured to increase system capacity.

Referring to FIG. 3, the multi-hop relay wireless communication system includes a BS 310, a plurality of MSs 311, 313, 321, 323, 331 and 333, and RSs 320 and 330 for providing multi-hop relay paths between BS 310 and the MSs. BS 310 manages a cell 300, and MSs 311, 313, 321, 323, 331 and 333 within the coverage area of cell 300 and RSs 320 and 330 can communicate directly with BS 310. Yet, the direct links between BS 310 and MSs 321, 323, 331 and 333 close to the boundary of cell 300 may have low Signal-to-Noise Ratios (SNRs). Therefore, RSs 320 and 330 provide high-speed data transmission paths to MSs 321, 323, 331 and 333, thereby increasing the effective data rates of the MSs and the system capacity.

In the multi-hop relay BWA communication systems illustrated in FIGS. 2 and 3, RSs 220, 260, 320 and 330 are infrastructure RSs installed and managed by BSs 210, 250 and 310, or client RSs, which SSs or MSs serve. RSs 220, 260, 320 and 330 may also be fixed, nomadic (e.g. laptop), or mobile (e.g. MSs).

In the above-described multi-hop relay wireless communication system, an RS serves the purpose of expanding cell coverage by relaying between a BS and an MS outside the coverage area of the BS or the purpose of increasing cell capacity by relaying between a BS and an MS within the coverage area of the BS. Irrespective of which purpose the RS serves, the BS should select an RS suitable for an MS. To do so, the BS may use channel status information between the MS and the RS. Accordingly, there is a need for defining a procedure for measuring the channel status between the MS and the RS by the MS or the RS and a procedure for reporting the MS-RS channel status measurement to the BS.

### SUMMARY OF THE INVENTION

An aspect of the present invention is to address at least the problems and/or disadvantages and to provide at least the advantages described below. Accordingly, an aspect of the present invention is to provide an apparatus and method for selecting an RS using an RS preamble signal in a multi-hop relay BWA communication system.

Another aspect of the present invention provides an apparatus and method for selecting an RS that increases cell coverage for an MS directly communicating with a BS in a multi-hop relay BWA communication system.

A further aspect of the present invention provides an apparatus and method for measuring the channel status between an MS and an RS and reporting the channel status measurement in a multi-hop relay BWA communication system.

In accordance with an aspect of the present invention, there is provided a method of selecting an RS in a BWA communication system, in which a BS sends preamble channel allocation information to at least one RS, the at least one RS sends a preamble to an MS according to the preamble channel allocation information, the MS measures the signal strength level of the preamble received from the at least one RS and reports the signal strength level to the BS, and the BS selects an RS for providing a relay service to the MS according to the signal strength level.

In accordance with another aspect of the present invention, there is provided a method of selecting an RS for a BS in a BWA communication system, in which the BS sends preamble channel allocation information to at least one RS, monitors reception of the signal strength level of a preamble signal sent by the at least one RS from an MS, and upon receipt of the signal strength level from the MS, selects an RS for providing a relay service to the MS according to the signal strength level.

In accordance with a further aspect of the present invention, there is provided a method of selecting an RS for an MS in a BWA communication system, in which upon receipt of a preamble from one of at least one RS and a BS, the MS measures the signal strength level of the preamble, and sends a signal strength level report message including the signal strength level to the BS.

In accordance with still another aspect of the present invention, there is provided an apparatus for selecting an RS in a BWA communication system, in which a BS sends preamble channel allocation information to at least one RS, monitors reception of the signal strength level of a preamble sent by the at least one RS from an MS, and selects an RS for providing a relay service to the MS according to the signal strength level, the at least one RS sends the preamble to the MS based on the preamble channel allocation information, and the MS measures the signal strength level of the preamble received from the at least one RS and reports the signal strength level to the BS.

### BRIEF DESCRIPTION OF THE DRAWINGS

The above and other objects, features and advantages of the embodiments of the present invention will be more apparent from the following detailed description taken in conjunction with the accompanying drawings, in which:

FIG. 1 illustrates the configuration of a typical IEEE 802.16e communication system;

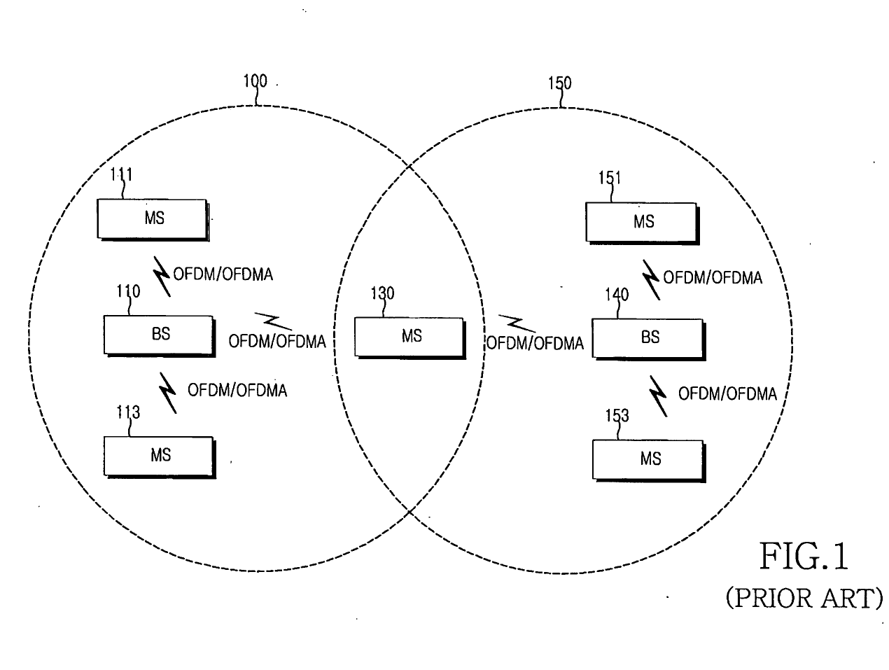

FIG. 2 illustrates the configuration of a multi-hop relay BWA communication system configured to expand the service coverage of a BS;

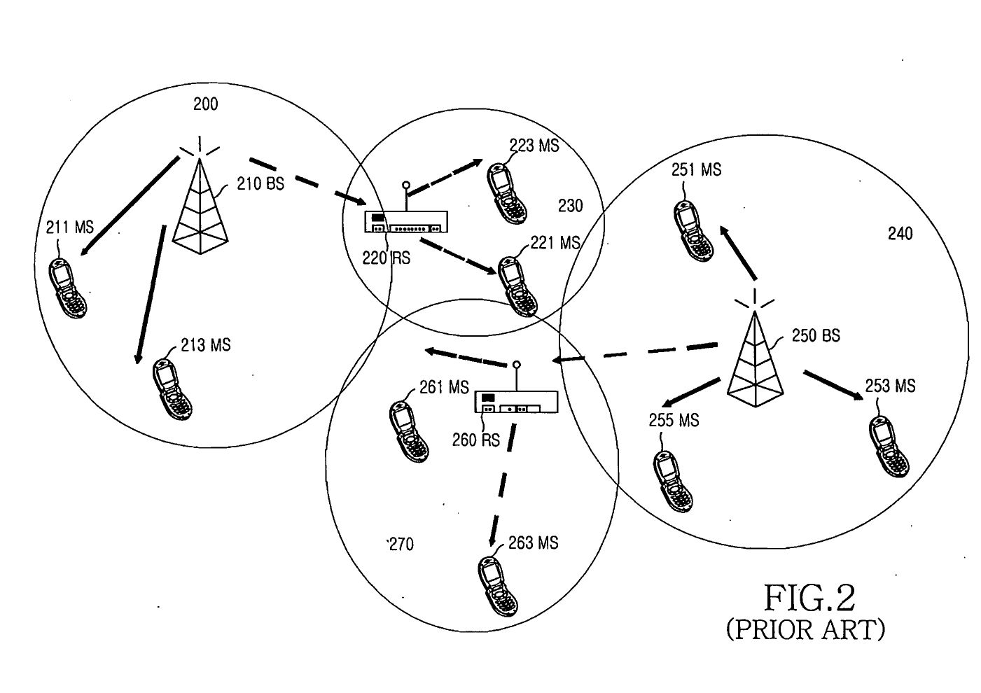

FIG. 3 illustrates the configuration of a multi-hop relay BWA communication system configured to increase system capacity;

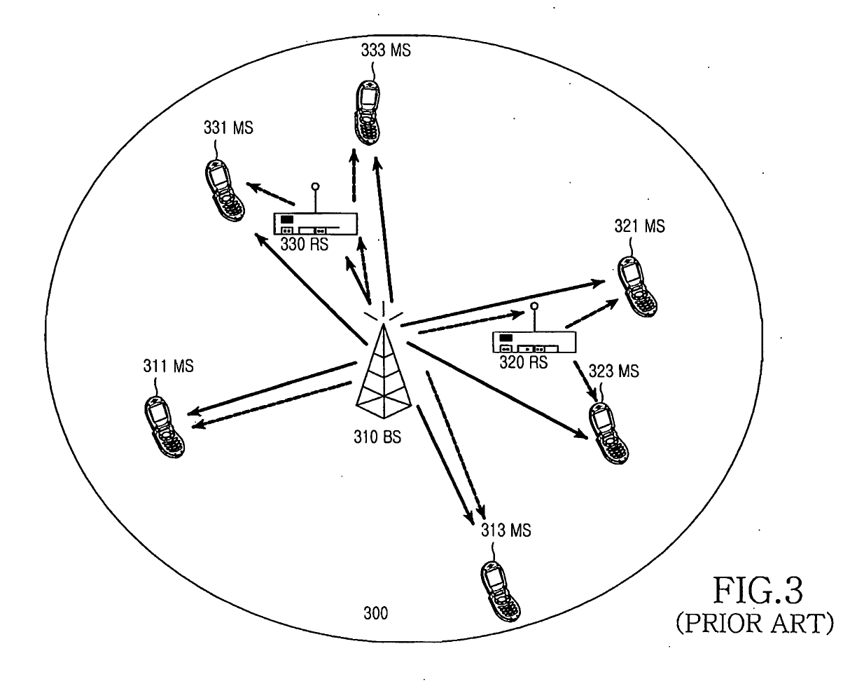

FIG. 4 is a flow diagram illustrating signal flow among a BS, an RS, and an MS, for selecting an RS to provide relay service to an MS in a multi-hop relay BWA communication system according to the present invention;

FIG. 5 is a flowchart showing the BS allocating an uplink bandwidth to the MS and receiving an MS-RS signal strength level measurement in the allocated uplink bandwidth from the MS in the multi-hop relay BWA communication system according to the present invention;

FIG. 6 is a flowchart showing the MS requesting allocation of an uplink area and reporting an MS-RS signal strength level measurement to the BS in the allocated uplink area in the multi-hop relay BWA communication system according to the present invention; and

FIG. 7 is a block diagram of the MS (or the RS or the BS) in the multi-hop relay BWA communication system according to the present invention.

### DETAILED DESCRIPTION OF THE PREFERRED EMBODIMENTS

The matters defined in the description such as detailed construction and elements are provided to assist in a comprehensive understanding of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The present invention provides an apparatus and method for selecting an RS using an RS preamble signal in a multi-hop relay BWA communication system.

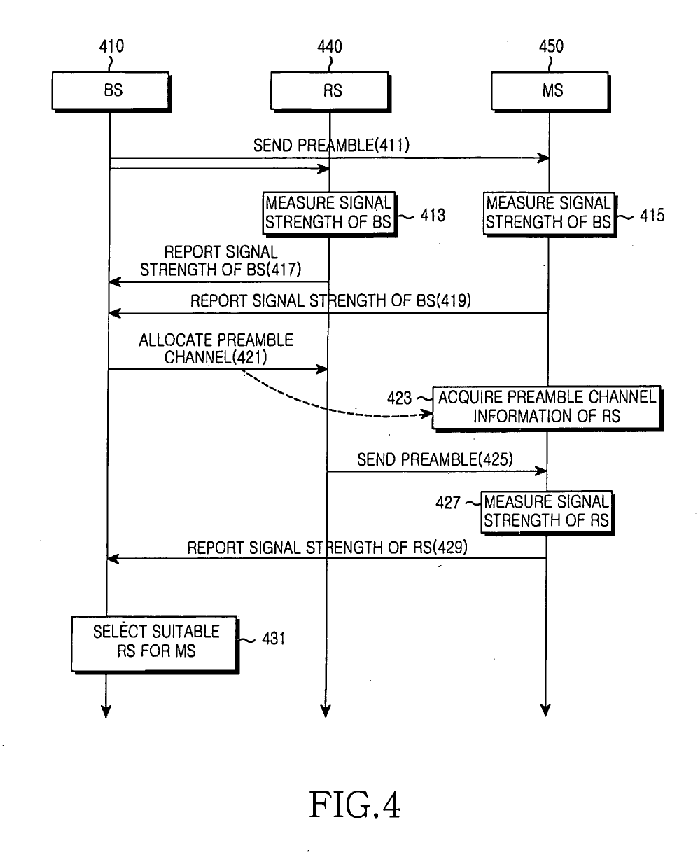

Referring to FIG. 4, a BS 410 sends a preamble to an RS 440 and an MS 450 in step 411. RS 440 and MS 450 measure the signal strength levels of the received preamble signal in steps 413 and 415 and report the signal strength level measurements to BS 410 in steps 417 and 419. The signal strength level measurements may be reported by sending Channel Quality Indicators (CQIs) on CQI Channels (CQICHs) or by sending Medium Access Control (MAC) management messages defined for signaling measurement reporting.

In step 421, BS 410 allocates a preamble zone, i.e. a preamble channel to RS 440 and sends preamble channel allocation information to RS 440 so that RS 440 sends a preamble signal to MS 450 based on the preamble channel allocation information. This step is performed for BS 410 to find out the RS-MS channel status. With knowledge of the RS-MS channel status, BS 410 can select an RS for providing a relay service to MS 450. The preamble channel allocation information indicates the preamble channel allocated to RS 440 and provides information about a preamble that RS 440 is to send to MS 450. For the allocation of the preamble channel, Preamble_Zone_Alloc_IE is defined using a bit value of Extended Downlink Interval Usage Code (Extended-DIUC) in a DownLink-MAP Information Element (DL-MAP IE).

The format of Preamble_Zone_Alloc_IE is given as follows.

TABLE 1

| Syntax | Size (bits) | Notes |
|---|---|---|
| Preamble_Zone_Alloc_IE( ) { | | |
| OFDMA symbol offset | 8 | |
| Subchannel offset | 8 | |
| No. OFDMA symbols | 1 | |
| No. subchannels | 7 | |
| } | | |

Referring to Table 1, OFDMA symbol offset represents the symbol offset of the preamble channel. Subchannel offset represents the subchannel offset of the preamble channel. No. OFDMA symbols represents the number of OFDMA symbols allocated to the preamble channel and No. subchannels represents the number of subchannels allocated to the preamble channel. BS 410 notifies RS 440 of the allocated preamble channel by Preamble_Zone_Alloc_IE.

To provide information about a preamble that RS 440 is to sent on the allocated preamble channel, BS 410 sends RS_Preamble_IE to RS 440 using a bit value of Extended-2 Downlink Interval Usage Code (Extended-2 DIUC) in DL-MAP IE.

RS_Preamble_IE has the following configuration.

TABLE 2

| Syntax | Size | Notes |
|---|---|---|
| RS_Preamble_IE( ) { | | |
| Extended-2 DIUC | 4 | RS_Preamble_IE( ) = 0x0B |
| Length | 8 | Variable |
| Preamble_relevance_flag | 1 | 0: preamble relevance is the same for all |
| | | CIDs |
| | | 1: preamble relevance is specified for each |
| | | CID |
| If (preamble relevance flag = = 0) { | | |
| preamble relevance | 1 | 0: all CIDs respond in the frame carrying the |
| | | instruction |
| | | 1: all CIDs respond in next frame |
| } | | |
| Preamble type | 2 | 00: occupy all subcarriers in the assigned |
| | | bands |
| | | 01: occupy decimated subcarriers |
| | | 10: hybrid (cyclic shift + decimation) |
| | | 11: reserved; shall be set to zero |
| If (preamble type == 00) { | | |
| Max cyclic shift index P | 3 | 0b000: P = 4 |
| | | 0b001: P = 8 |
| | | 0b010: P = 16 |
| | | 0b011: P = 32 |
| | | 0b100: P = 9 |
| | | 0b101: P = 18 |
| | | 0b110-0b111: reserved |
| } | | |
| else if (preamble type == 01) { | | |
| decimation value D | 3 | This value is determined according to the |
| | | number of RSs |
| decimation offset randomization | 1 | 0: no randomization of decimation offset |
| | | 1: decimation offset pseudo-randomly |
| | | determined |
| } | | |
| else if (preamble type == 10) { | | |
| max cyclic shift index P | 3 | 0b000: P = 4 |
| | | 0b001: P = 8 |
| | | 0b010: P = 16 |
| | | 0b011: P = 32 |
| | | 0b100: P = 9 |
| | | 0b101: P = 18 |
| | | 0b110-0b111: reserved |
| decimation value D | 3 | |
| decimation offset randomization | 1 | 0: no randomization of decimation offset |
| | | 1: decimation offset pseudo-randomly |
| | | determined |
| } | | |
| number of CIDs | 6 | Number of CIDs sharing this preamble |
| | | allocation |
| for (i = 0; i < number of CIDs; i ++){ | | |
| CID | 16 | RS CID |
| Power assignment method | 2 | 0b00: equal power |
| | | 0b01: interference dependent. Per subcarrier |
| | | power limit |
| | | 0b10: interference dependent. Total power |
| | | limit |
| | | 0b11: reserved |
| Power boost | 1 | 0: no power boost |
| | | 1: power boost |
| Allocation mode | 1 | 0: normal |
| | | 1: band AMC |
| if (allocation mode ==) { | | |
| Band bit MAP | 2 | Logical band defined in 6.3.18 |
| } | | |
| else{ | | |
| starting frequency band | 7 | Out of 96 bands at most (FFT size |
| | | dependent) |
| number of frequency bands | 7 | Contiguous bands used for preamble |
| } | | |
| if (preamble relevance flag == 1) { | | |
| preamble relevance | 1 | |
| } | | |
| if (preamble type == 00) { | | |
| cyclic time shift index m | 5 | Cyclically shifts the time domain symbol by |
| | | multiples (from 0 to P-1) of N/P where |
| | | N = FFT size and P = max cyclic shift index |
| } | | |
| else if (preamble type == 01) { | | |
| decimation offset d | 6 | Relative starting offset position for the first |
| | | preamble occupied subcarrier in the |
| | | preamble allocation |
| } | | |
| else if (preamble type == 10) { | | |
| decimation offset d | 6 | Relative starting offset position for the first |
| | | preamble occupied subcarrier in the |
| | | preamble allocation |
| cyclic time shift index m | 5 | Cyclically shifts the time domain symbol by |
| | | multiples (from 0 to P-1) of N/P where |
| | | N = FFT size and P = max cyclic shift index |
| } | | |
| periodicity | 3 | 0b000: single command, not periodic, or |
| | | terminate periodicity. |
| | | Otherwise, repeat preamble once per r |
| | | frame, where r = 2(n − 1), where n is the |
| | | decimal equivalent of the periodicity field. |
| } | | |
| } | | |

In Table 2, Extended-2 DIUC is set to 0×0B to identify RS_Preamable_IE. Preamable_relevance_ flag indicates whether the same preamble relevance applies to all CIDs or preamble relevance is specified for each CID. Preamble type identifies a preamble channel allocation type. If preamble type is 00, cyclic shift information is included to identify a preamble signal that the RS sends in the preamble channel. If preamble type is 01, decimation information is included to identify a preamble signal that the RS sends in the preamble channel. If preamble type is 10, decimation shift information and cyclic shift information are included to identify a preamble signal that the RS sends in the preamble channel. The preamble type 10 is a hybrid allocation type corresponding to a combination of the preamble type 00 and the preamble type 01. For example, the BS can allocate a decimation-type preamble channel group to RSs and allocate a cyclic shift-type preamble channel to each RS. In addition, RS_Preamble_IE includes the CIDs of RSs to be allocated the preamble channel and send preambles on the preamble channel, and the preamble type, preamble relevance, and periodicity of each RS. Periodicity indicates whether the RS is to send a preamble periodically, and in the case of periodic transmission, it also indicates a preamble transmission period. Upon receipt of RS_Preamable_IE, RS 440 configures a preamble signal based on the above-described information. A formula and a sequence table required for the preamble configuration may be given during system setting.

BS 410 may instruct some RSs or all RSs to send preambles to the MS and may also instruct each RS to periodically send a preamble by RS_Preamble_IE. Also when BS 410 wants a specific RS to send a preamble at a specific time instant, it can send RS_Preamable_IE to the RS.

In step 423, MS 450 also receives the preamble channel allocation information described in Table 1 and Table 2 from BS 410. It is assumed herein that MS 450 has prior knowledge of the CID of RS 440 and the formula and sequence table required for preamble configuration in RS 440.

RS 440 sends its preamble to MS 450 according to the preamble channel allocation information in step 425. MS 450 measures the MS-RS signal strength level of the preamble in step 427 and reports the MS-RS signal strength level to BS 410 in step 429.

In step 431, BS 410 selects RS 440 suitable for MS 450 based on the MS-RS signal strength level received from MS 450 and a BS-RS signal strength level measured with respect to RS 440. RS 440 may be an RS in the best channel status from BS 410 to MS 450 and MS 450 can receive a relay service from RS 440. To continuously monitor the channel status between RS 440 and MS 450 during the relay service, BS 410 can allocate a preamble channel to RS 440 and instructs RS 440 to send a preamble signal to MS 450, while instructing MS 450 to measure the RS-MS channel status by the preamble signal and report it to BS 410.

Also, BS 410 may instruct a specific or all RSs to send preamble signals at a specific instant in time to thereby enable the MS to monitor the RS-MS channel statuses.

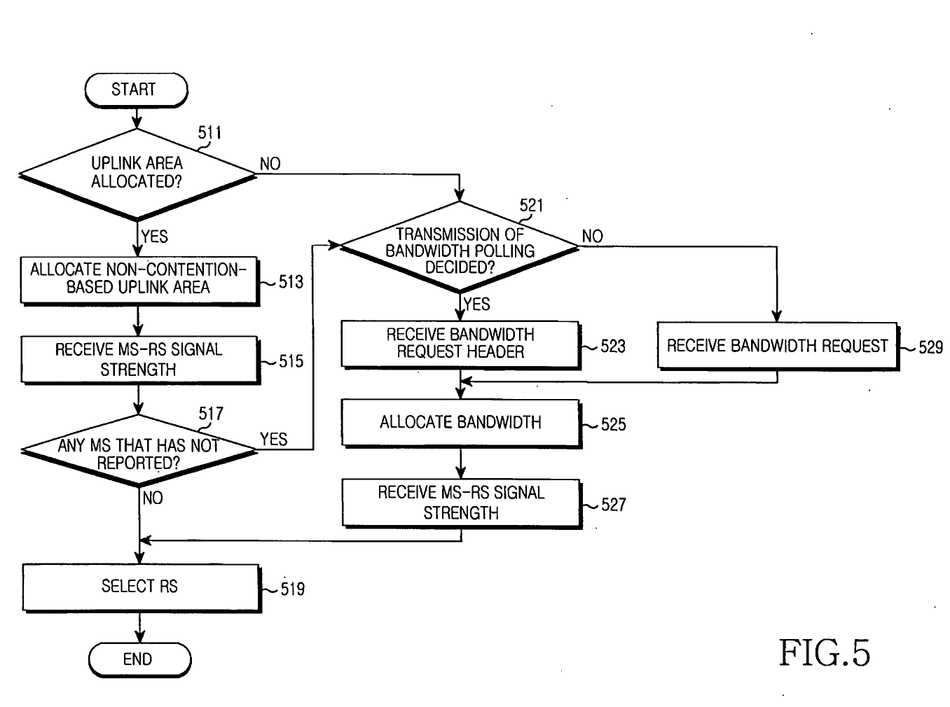

Referring to FIG. 5, the BS determines whether to allocate a non-contention-based uplink area to an MS on which the MS will report an MS-RS signal strength level in step 511. If it determines to allocate the non-contention-based uplink area to the MS, the BS allocates the uplink area to the MS in step 513. The uplink area allocation can be carried out through UpLink-MAP Information Element (UL-MAP IE). In accordance with the present invention, MS_Signal_Report_IE indicating the allocated uplink area is defined using a reserved bit value of Extended-2 Uplink Interval Usage Code (Extended-2 UIUC).

MS_Signal_Report_IE has the following configuration.

TABLE 3

| Syntax | Size (bits) | Notes |
|---|---|---|
| MS_Signal_Report_1E( ) { | | |
| Extended-2 UIUC | 4 | MS_Signal_Report_IE( ) = |
| | | 0x09 |
| CID | 16 | MS CID |
| Duration | 6 | Indicates the duration, |
| | | in units of OFDMA |
| | | slots, of the allocation |
| Reserved | 6 | Reserved; shall be set to zero |
| } | | |

In Table 3, Extended-2 UIUC is set to 0×09 to identify MS_Signal_Report_IE. MS_Signal_Report_IE further includes CID representing the basic CID of the MS to which the uplink area is allocated and duration representing the duration of the allocation of the uplink area in which the MS is to report an MS-RS signal strength level.

In step 515, the BS receives an MS-RS signal strength level report message, MS_Signal_Report, from the MS in the allocated uplink area.

MS_Signal_Report is configured as follows.

TABLE 4

| Syntax | Size | Notes |
|---|---|---|
| MS_Signal_Report_Message_format( ) { | | |
| Management message type = TBD | 8 | To be determined |
| N_RSs | 8 | Number of RSs reported n this message |
| for (i = 0; i < N_RSs; i ++) { | | |
| RS preamble index | 8 | RS preamble index |
| MS-RS signal strength level | 8 | |
| } | | |
| } | | |

Referring to Table 4, MS_Signal_Report message includes information about the management message type of the transmitted message, the number of RSs about which the MS reports, the preamble indexes of the RSs, and the MS-RS signal strength levels of the RSs. The signal strength levels may be given as Signal-to-Interference and Noise Ratios (SINRs) or Received Signal Strength Indicators (RSSIs).

In step 517, the BS determines whether there is any MS that has not reported an MS-RS signal strength level yet. If every MS has reported, the BS selects a suitable RS for each MS based on the received MS-RS signal strength level in step 519 and then ends the algorithm of the present invention.

If the BS determines not to allocate the non-contention-based uplink area for signal strength reporting to each MS in step 511 or if there is any MS that has not reported an MS-RS signal strength level yet in step 517, the BS sends a bandwidth polling, the BS can send a bandwidth polling to each MS so that the MS can request bandwidth allocation for sending the MS_Signal_Report message reporting an MS-RS signal strength level. For this purpose, the BS decides as to whether to send a bandwidth polling to the MS in step 521. If it so decides, the BS sends the bandwidth polling to the MS and receives a bandwidth request header from the MS in step 523. On the other hand, if the BS decides not to send the bandwidth polling, it receives a bandwidth request from the MS without sending the bandwidth polling to the MS in step 529. The bandwidth request can be based on contention, made by the MS according to its decision.

The BS allocates a required uplink area to the MS in step 525 and in step 527 receives an MS-RS signal strength level from the MS through the MS_Signal_Report message illustrated in Table 4 in the allocated uplink area. The BS then selects a suitable RS for the MS based on the MS-RS signal strength level in step 519 and ends the procedure.

In step 523 or step 529, the BS may receive the bandwidth request from the MS by a general bandwidth request header or a newly defined MS signal report extended subheader according to the present invention. By MS signal report extended subheader, the MS can notify the BS that the MS requests a bandwidth for a reported MS-RS signal strength and also notify the BS of the number of RSs regarding which the MS will report MS-RS signal strength levels. The BS then may allocate an uplink area corresponding to the number of RSs to be reported to the MS.

The MS extended subheader signal report is configured as follows.

TABLE 5

| | | |
|---|---|---|
| Name | Size (bits) | Description |

| | | |
|---|---|---|
| RS number | 8 | The number of RSs regarding which MS |
| | | reports signal strength measurements |

As noted in Table 5, the MS extended subheader signal report includes the number of RSs regarding which the MS will report MS-RS signal strength levels. Therefore, the BS detects the level of an MS-RS signal strength report from the MS and allocates an uplink area corresponding to the reported level to the MS.

Instead of a MAC management message like the MS_Signal_Report message of Table 4, the MS may report the MS-RS signal strength level to the BS in a code sequence of the preamble index of the RS and the MS-RS signal strength level in combination.

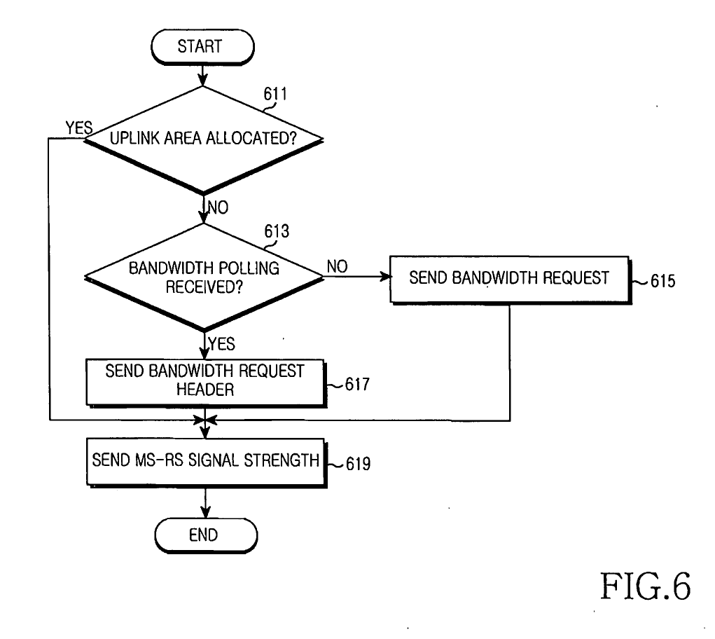

Referring to FIG. 6, the MS determines if a non-contention-based uplink area has been allocated in which the MS can report an MS-RS signal strength, as described in Table 3 in step 611. If the non-contention-based uplink area has been allocated, the MS reports the MS-RS signal strength level to the BS by the MS_Signal_Report message of Table 4 in the allocated uplink area in step 619. On the other hand, if the non-contention-based uplink area has not been allocated, the MS monitors reception of a bandwidth polling from the BS in step 613. Upon receipt of the bandwidth polling, the MS sends a bandwidth request header to the BS, requesting an uplink area in which to report the MS-RS signal strength in step 617. If the bandwidth polling is not received from the BS or if the MS decides to request a contention-based bandwidth allocation, the MS sends a bandwidth request code and a bandwidth request header to the BS, requesting allocation of an uplink area in step 615. The MS then is allocated the uplink area and reports the MS-RS signal strength level to the BS by the MS_Signal_Report message of Table 4 in the allocated uplink area in step 619. The MS ends the process. The MS-RS signal strength level is the MS-measured strength level of a preamble signal received from the RS.

The bandwidth request header sent in step 615 or step 617 can be the general bandwidth request header or the newly defined MS signal report extended subheader described in Table 5 according to the present invention. Instead of a MAC management message like the MS_Signal_Report message of Table 4, the MS may report the MS-RS signal strength level to the BS in a code sequence of the preamble index of the RS and the MS-RS signal strength level in combination.

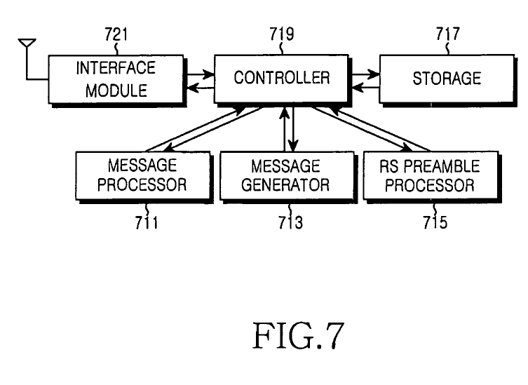

Referring to FIG. 7, since the MS, the RS and the BS have the same interface module (i.e. communication module), their operations will be described as a single device. The MS, the RS and the BS each commonly have a controller 719, a message processor 711, a message generator 713, an RS preamble processor 715, a storage 717, and an interface module 721.

Regarding the MS configuration, controller 719 provides overall control of the operation of the MS. For example, controller 719 processes and controls voice communication and data communication. In addition to the typical functionalities, controller 719 processes a preamble signal received from the RS on a preamble channel allocated to the RS according to the present invention. Controller 719 provides a control message received from the BS or the RS to message processor 711 and provides a transmission message for the BS or the RS received from message generator 713 to interface module 721.

Message processor 711 analyzes the control message and provides the analysis result to controller 719. In accordance with the present invention, upon receipt of a DL-MAP message including Preamble_Zone_Alloc_IE described in Table 1 and RS_Preamable_IE described in Table 2, or a UL-MAP message including MS_Signal_Report_IE described in Table 3, the message processor 711 extracts control information from the received message and provides the control information to controller 719. Controller 719 controls RS preamble processor 715 based on the control information.

Message generator 713 generates the transmission message for the BS or the RS under the control of controller 719. The MS_Signal_Report message of Table 4 or the MS extended subheader signal report of Table 5 generated in message generator 713 according to the present invention is provided to interface module 721 through controller 719.

Under the control of controller 719, RS preamble processor 715 receives the preamble signal from the RS on the preamble channel allocated to the RS, measures the signal strength of the preamble signal, and provides information associated with reporting of the MS-RS signal strength level to the BS to controller 719.

Storage 717 stores programs for controlling the whole operation of the MS and temporary data generated during execution of the programs. Typically, storage 717 can store data and control information to be sent to the BS, and a formula associated with the RS preamble signal and a preamble sequence table according to the present invention.

Interface module 721 is a module for interfacing with the BS or the RS and includes a Radio Frequency (RF) processor and a baseband processor. The RF processor downconverts a signal received through an antenna to a baseband signal processor, and upconverts a baseband signal received from the baseband processor to an RF signal processor for transmission through the antenna. In a BWA scheme, for example, the baseband processor acquires original information data by Fast Fourier Transform (FFT) processing and channel decoding the signal received from the RF processor and provides the original information data to controller 719. The baseband processor also channel-encodes and Inverse Fast Fourier Transform (IFFT) processes data received from controller 719 and provides the IFFT signal to the RF processor.

Regarding the RS configuration, controller 719 provides overall control to the operation of the RS. For example, controller 719 processes and controls voice communication and data communication. In addition to the typical functionalities, controller 719 provides a relay service of an RS within a serving cell, particularly an RS supporting the increase of the capacity of the serving cell to the MS according to the present invention. Controller 719 provides a control message received from the BS or the MS to message processor 711 and provides a transmission message for the BS or the MS received from message generator 713 to interface module 721.

Message processor 711 analyzes the control message and provides the analysis result to controller 719. In accordance with the present invention, upon receipt of a DL-MAP message including Preamble_Zone_Alloc_IE described in Table 1 and RS_Preamble_IE described in Table 2, message processor 711 extracts control information from the received message and provides the control information to controller 719. Controller 719 operates in accordance with the control information.

Message generator 713 generates the transmission message for the BS or the MS that the RS manages under the control of controller 719. According to the present invention, message generator 713 generates the preamble signal to be sent in the preamble channel allocated from the BS. The message generated from message generator 713 is provided to interface module 721 through controller 719.

Under the control of controller 719, RS preamble processor 715 operates to send its preamble signal on the preamble channel based on information indicated by Preamble_Zone_Alloc_IE and RS_Preamble_IE.

Storage 717 stores programs for controlling the whole operation of the RS and temporary data generated during execution of the programs. Typically, storage 717 can store data and control information to be sent to the BS or the MS. According to the present invention, storage 717 can store a preamble sequence table and a preamble generator formula for generating the preamble signal.

Interface module 721 is a module for interfacing with the BS or the MS and includes the RF processor and the baseband processor. The RF processor downconverts a signal received through an antenna to a baseband signal, and upconverts a baseband signal received from the baseband processor to an RF signal processor for transmission through the antenna. In a BWA scheme, for example, the baseband processor acquires original information data (traffic or a control message) by FFT processing and channel decoding the signal received from the RF processor and provides the original information data to controller 719. The baseband processor also channel-encodes and IFFT-processes data received from controller 719 and provides the IFFT signal to the RF processor.

Regarding the BS configuration, controller 719 provides overall control to the operation of the BS. For example, controller 719 controls voice communication and data communication. In addition to the typical functionalities, controller 719 operates to provide a relay service of an RS within a serving cell, particularly an RS supporting the increase of the capacity of the serving cell to the MS according to the present invention. According to the present invention, controller 719 provides a control message received from the RS or the MS to message processor 711 and provides a transmission message for the RS or the MS received from message generator 713 to interface module 721.

Message processor 711 analyzes the control message and provides the analysis result to controller 719. In accordance with the present invention, upon receipt of the MS_Signal_Report message of Table 4 or the MS signal report extended subheader of Table 5, message processor 711 extracts control information from the received message and provides the control information to controller 719. Controller 719 operates based on the control information.

Message generator 713 generates the transmission message for the RS or the MS under the control of controller 719. According to the present invention, message generator 713 generates a DL-MAP message including Preamble_Zone_Alloc_IE of Table 1 or RS_Preamable_IE of Table 2 which includes information required for sending a preamble signal from the RS, or a UL-MAP message including MS_Signal_Report_IE of Table 3 including information required for sending an MS-RS signal strength level from the MS. The message generated from message generator 713 is provided to interface module 721 through controller 719.

Under the control of controller 719, RS preamble processor 715 determines a preamble channel to be allocated to the RS, receives an MS_RS signal strength report from the MS, and operates to select a suitable RS for the MS.

Storage 717 stores programs for controlling the whole operation of the BS and temporary data generated during execution of the programs. Typically, storage 717 can store data and control information to be sent to the RS or the MS.

Interface module 721 is a module for interfacing with the RS or the MS and includes the RF processor and the baseband processor. The RF processor downconverts a signal received through an antenna to a baseband signal, and upconverts a baseband signal received from the baseband processor to an RF signal for transmission through the antenna. In a BWA scheme, for example, the baseband processor acquires original information data (traffic or a control message) by FFT processing and channel decoding the signal received from the RF processor and provides the original information data to controller 719. The baseband processor also channel-encodes and IFFT-processes data received from controller 719 and provides the IFFT signal to the RF processor.

In any of the MS, RS and BS, controller 719 controls message processor 711, message generator 713, and RS preamble processor 715. That is, controller 719 may perform the functionalities of message processor 711, message generator 713, and RS preamble processor 715.

As is apparent from the above description, the embodiments of the present invention provide a method in which to detect the channel status between an RS and an MS; a BS allocates a preamble channel for sending a preamble signal to the RS and receives the MS-RS signal strength of the preamble signal from the MS. Therefore, MSs communicating directly with the BS can receive a relay service at an increased effective transmission rate via excellent radio link channels provided by the RS.

While the invention has been shown and described with reference to certain preferred embodiments thereof, it will be understood by those skilled in the art that various changes in form and details may be made therein without departing from the spirit and scope of the invention as further defined by the appended claims.

What is claimed is:

1. A method of selecting a Relay Station (RS) in a wireless communication system, comprising:
sending preamble channel allocation information to at least one RS by a Base Station (BS);
sending a preamble signal to a Mobile Station (MS) according to the preamble channel allocation information by the at least one RS;
measuring the signal strength level of the preamble received from the at least one RS and reporting the signal strength level to the BS by the MS; and
selecting an RS for providing a relay service to the MS according to the signal strength level received by the BS.

2. The method of claim 1, further comprising:
sending a preamble to the at least one RS and the MS by the BS; and
measuring the signal strength levels of the preamble and reporting the signal strength levels to the BS by the at least one RS and the MS.

3. The method of claim 1, wherein the preamble channel allocation information includes at least one of information about a preamble channel allocated to the at least one RS and information about the preamble that the at least one RS is to send to the MS.

4. The method of claim 1, wherein the selected RS provides the best channel status between the BS and the MS.

5. The method of claim 3, wherein the information about the preamble channel is carried in a preamble zone allocation Information Element (IE) using a bit value of an Extended-DownLink Interval Usage Code (Extended-DIUC) in a DownLink-MAP (DL-MAP) IE.

6. The method of claim 5, wherein the preamble zone allocation IE comprises at least one of an Orthogonal Frequency Division Multiple Access (OFDMA) symbol offset of the preamble channel, a subchannel offset of the preamble channel, the number of OFDMA symbols allocated to the preamble channel, and the number of subchannels allocated to the preamble channel.

7. The method of claim 3, wherein the preamble information is carried in an RS preamble IE using a bit value of an Extended-2 DownLink Interval Usage Code (Extended-2 DIUC) in the DL-MAP IE.

8. The method of claim 7, wherein the RS preamble IE comprises at least one of the Extended-2 DIUC, preamble relevance, a preamble relevance flag indicating whether the preamble relevance applies to all Connection Identifiers (CIDs) or is specified for each CID, a preamble type indicating a preamble channel allocation type, at least one of cyclic shift information and decimation information to identify a preamble sent on a preamble channel by an RS, a CID of the RS to be allocated, the preamble channel and to send the preamble on the preamble channel, and periodicity indicating whether the RS is to send the preamble periodically and indicating a preamble transmission period.

9. A method of selecting a Relay Station (RS) for a Base Station (BS) in a wireless communication system, comprising:
sending preamble channel allocation information to at least one RS and monitoring reception of the signal strength level of a preamble signal sent by the at least one RS from a Mobile Station (MS); and
selecting, upon receipt of the signal strength level from the MS, an RS for providing a relay service to the MS according to the signal strength level.

10. The method of claim 9, further comprising:
sending a preamble to the at least one RS and the MS; and
monitoring reception of the signal strength levels of the preamble from the at least one RS and the MS.

11. The method of claim 9, further comprising:
determining whether to allocate an uplink area for receiving the signal strength level of the preamble sent by the at least one RS to the MS;
allocating a non-contention-based uplink area to the MS, when the BS determines to allocate an uplink area; and
determining whether to send a bandwidth polling when the BS determines not to allocate an uplink area or when there is any MS that has not sent a signal strength level to the BS.

12. The method of claim 11, wherein the uplink area is indicated by an MS signal report Information Element (IE) using a bit value of an Extended-2 UpLink Interval Usage Code (Extended-2 UIUC) in an UpLink-MAP (UL-MAP) IE.

13. The method of claim 12, wherein the MS signal report IE includes at least one of a Connection Identifier (CID) of the MS to which the uplink area is allocated and a duration of allocation of the uplink area in which the signal strength level is reported.

14. The method of claim 11, further comprising:
sending the bandwidth polling to the MS and receiving a bandwidth request header from the MS, when the BS determines to send the bandwidth polling;
receiving a bandwidth request from the MS when the BS determines not to send the bandwidth polling; and
allocating a requested bandwidth to the MS.

15. The method of claim 14, wherein the bandwidth request header comprises the level of a signal strength level report.

16. A method of selecting a Relay Station (RS) in a Mobile Station (MS) in a wireless communication system, comprising:
measuring, upon receipt of a preamble from one of at least one RS and a Base Station (BS), the signal strength level of the preamble; and
sending a signal strength level report message including the signal strength level to the BS.

17. The method of claim 16, further comprising:
determining if an uplink area for reporting the signal strength level has been allocated from the BS; and
determining if a bandwidth polling has been received from the BS and sending a bandwidth request header to the BS if the bandwidth polling has been received from the BS and being allocated a bandwidth, if the uplink area has not been allocated, sending a bandwidth request to the BS if the bandwidth polling has not been received from the BS.

18. The method of claim 17, wherein the bandwidth request header comprises the level of a signal strength level report.

19. The method of claim 16, wherein the signal strength level report message includes at least one of the type of a transmitted message, the number of RSs regarding which the MS is to report, the preamble index of each of the RSs, and an MS-RS signal strength level of the each RS.

20. An apparatus for selecting a Relay Station (RS) in a wireless communication system, comprising:
a Base Station (BS) for sending preamble channel allocation information to at least one RS and monitoring reception of the signal strength level of a preamble sent by the at least one RS from a Mobile Station (MS), and selecting an RS for providing a relay service to the MS according to the signal strength level;
the at least one RS for sending the preamble to the MS based on the preamble channel allocation information; and
the MS for measuring the signal strength level of the preamble received from the at least one RS and reporting the signal strength level to the BS.

21. The apparatus of claim 20, wherein the preamble channel allocation information comprises at least one of information about a preamble channel allocated to the at least one RS and information about the preamble that the at least one RS is to send to the MS on the preamble channel.
